(19) United States
(12) Patent Application Publication
(10) Pub. No.: US 2024/0205789 A1
(43) Pub. Date: Jun. 20, 2024

(54) MULTI-PATH OPERATION IN UE-TO-NW SIDELINK RELAY

(71) Applicant: Apple Inc., Cupertino, CA (US)

(72) Inventors: Zhibin WU, Los Altos, CA (US); Alexander SIROTKIN, Hod Hasharon (IL); Fangli XU, Beijing (CN); Haijing HU, Los Gatos, CA (US); Naveen Kumar R PALLE VENKATA, San Diego, CA (US); Pavan NUGGEHALLI, San Carlos, CA (US); Ralf ROSSBACH, Munich (DE); Sarma V VANGALA, Campbell, CA (US); Sethuraman GURUMOORTHY, San Ramon, CA (US); Yuqin CHEN, Beijing (CN)

(21) Appl. No.: 17/906,121

(22) PCT Filed: Sep. 24, 2021
(86) PCT No.: PCT/CN2021/120337

§ 371 Date: Sep. 12, 2022

(51) Int. Cl. H04W 40/12; H04W 8/22; H04W 40/24; H04W 74/0833

(52) U.S. Cl. CPC H04W 40/12; H04W 8/22; H04W 40/248; H04W 74/0833

(57) ABSTRACT

Embodiments of the present disclosure relate to multi-path operation. According to embodiments of the present disclosure, a measurement report is transmitted to a base station on a first path between the UE and the base station, wherein the measurement report indicates channel quality information on one or more potential paths between the UE and the base station. A path addition command is then received from the base station, wherein the path addition command indicates the UE to add a path from one or more potential paths as a second path. The second path between the UE and the base station is then established based on the path addition command.

### TECHNICAL FIELD

Embodiments of the present disclosure generally relate to the field of telecommunications, and in particular, to multi-path operation in user equipment to network (UE-to-NW) sidelink (SL) relay.

### BACKGROUND

Third Generation Partnership Project (3GPP) Fifth Generation (5G) New Radio (NR) provides for communication between user equipment (UE) and a base station (BS), for example, a next generation Node B (gNB). Operation and coordination of these network devices is defined through Technical Specifications (TSs) periodically released by 3GPP. In NR system, the UE-to-NW sidelink relay was introduced and thus multi-path operations between a remote UE and the BS are supported.

### SUMMARY

In general, example embodiments of the present disclosure provide a solution for multi-path operation in UE-to-NW sidelink relay.

In a first aspect, there is provided a processor of user equipment. The processor is configured to perform operations comprising transmitting to a base station a measurement report on a first path between the UE and the base station, wherein the measurement report indicates channel quality information on one or more potential paths between the UE and the base station; receiving a path addition command from the base station, wherein the path addition command instructs the UE to add a path from the one or more potential paths as a second path; establishing the second path between the UE and the base station based on the path addition command.

In a second aspect, there is provided a processor of user equipment. The processor is configured to perform operations comprising receiving a conditional path addition (CPA) command from the base station on a first path between the UE and the base station, wherein the CPA command indicates CPA configurations including CPA trigger conditions and multi-path configuration; executing the CPA command in accordance with determination that at least one of the CPA trigger conditions is fulfilled; and establishing the second path between the UE and the base station in accordance with the determination that the CPA is to be executed.

In a third aspect, there is provided a processor of user equipment. The processor is configured to perform operations comprising receiving from a base station a multi-path configuration via a signaling. In particular, the multi-path configuration comprises at least one of traffic split configuration and traffic duplication configuration regarding one or more of one or more radio bearers, uplink (UL) traffic, downlink (DL) traffic, user plane (UP) traffic, or control plane (CP) traffic on a direct path and an indirect path.

In a fourth aspect, there is provided a processor of user equipment. The processor is configured to perform operations comprising determining a path failure among multiple paths between the UE and a base station, transmitting a path failure information to the network on a failure-free path of the multiple paths, wherein the path failure information contains information on determined path failure; and performing a path recovery operation.

In fifth aspect, there is provided user equipment. The user equipment comprises a transceiver and a processor of any of the first to the fourth aspects. The transceiver is communicatively coupled to the processor and configured to communicate with a network.

In a sixth aspect, there is provided a processor of a base station. The processor is configured to perform operations comprising receiving from user equipment (UE) a measurement report on a first path between the UE and the base station, wherein the measurement report indicates channel quality information on one or more potential paths between the UE and the base station; determining a second path to be added from the one or more potential paths based on the measurement report; transmitting a path addition command to the UE, wherein the path addition command instructs the UE to add a second path; assisting to establish the second path between the UE and the base station.

In a seventh aspect, there is provided a processor of a base station. The processor is configured to perform operations comprising: determining CPA trigger conditions and multi-path configuration for the UE; transmitting a conditional path addition (CPA) command from the base station on a first path between the UE and the base station, wherein the CPA command indicates CPA configurations including CPA trigger conditions and multi-path configuration; and assisting to establish a second path between the UE and the base station.

In an eighth aspect, there is provided a processor of a base station. The processor is configured to perform operations comprising transmitting to the UE a multi-path configuration via a signaling, wherein the multi-path configuration comprises at least one of traffic split configuration and traffic duplication configuration regarding one or more of one or more radio bearers, uplink (UL) traffic, downlink (DL) traffic, user plane (UP) traffic, or control plane (CP) traffic.

In a ninth aspect, there is provided a processor of a base station. The processor is configured to perform operations comprising receiving a path failure information to the network on a failure-free path of the multiple paths, wherein the path failure information contains information on determined path failure; and performing a path recovery operation based on the path failure information.

In a tenth aspect, there is provided a base station. The base station comprises a transceiver and a processor of any of the sixth to ninth aspects. The transceiver is configured to be communicatively coupled to the processor and to communicate with user equipment.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows a schematic diagram of an example communication network supporting UE to NW relay;

FIG. 2 illustrates a schematic diagram of an example communication network in which example embodiments of the present disclosure can be implemented;

FIG. 3 illustrates a schematic diagram of multi-path architecture according to some embodiments of the present disclosure;

FIG. 4 illustrates a flowchart of a method of path adding in multi-path operations at a UE side according to some embodiments of the present disclosure;

FIG. 5 illustrates a flowchart of a method of conditional path adding in multi-path operations at a UE side according to some embodiments of the present disclosure;

FIG. 6 illustrates a schematic diagram of CPA configurations according to some embodiments of the present disclosure.

FIG. 7 illustrates a flowchart of a method of multi-path configuration at a UE side according to some embodiments of the present disclosure;

FIG. 8 illustrates a schematic diagram of multi-path configuration options according to some embodiments of the present disclosure;

FIG. 9 illustrates a flowchart of a method of failure path recovery at a UE side according to some embodiments of the present disclosure;

FIG. 10 illustrates a flowchart of a method of path adding in multi-path operations at a BS side according to some embodiments of the present disclosure;

FIG. 11 illustrates a flowchart of a method of conditional path adding in multi-path operations at a BS side according to some embodiments of the present disclosure;

FIG. 12 illustrates a flowchart of a method of multi-path configuration at a BS side according to some embodiments of the present disclosure;

FIG. 13 illustrates a flowchart of a method of failure path recovery at a BS side according to some embodiments of the present disclosure;

FIG. 14 illustrates a signaling chart of a method of direct path adding in multi-path operations according to some embodiments of the present disclosure;

FIG. 15 illustrates a signaling chart of a method of indirect path adding in multi-path operations according to some embodiments of the present disclosure;

FIG. 16 illustrates a signaling chart of a method of conditional direct path adding in multi-path operations according to some embodiments of the present disclosure;

FIG. 17 illustrates a signaling chart of a method of conditional indirect path adding in multi-path operations according to some embodiments of the present disclosure;

FIG. 18 illustrates a flowchart of a method of failure path recovery for the direct path according to some embodiments of the present disclosure;

FIG. 19 illustrates a flowchart of a method of failure path recovery for the indirect path according to some embodiments of the present disclosure; and

FIG. 20 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

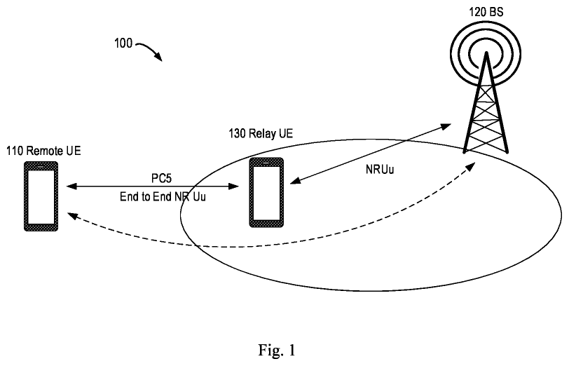

As mentioned above, the NR system supports the UE-to-NW sidelink relay. As illustrated in FIG. 1. In the communication network 100, the remote UE 110 is out of coverage of BS 120 such as a gNB; however, the remote UE 110 is assessable and controllable by the BS 120 via the relay UE 130. Thus, in NR system, the remote UE 110 is coupled with relay the UE 130 on the PC5 link through an end to end NR Uu interface and the relay UE 130 is coupled with the BS 120 on the direct radio link via NR Uu interface. Thus, system information block (SIB) and paging information can be forwarded by the BS 120 via the relay UE 130 to the remote UE 110 which is out of coverage. In such a way, the coverage of the BS is extended by means of Layer-2 approach.

For a purpose of reliability and throughput enhancements, it is proposed to enable a multi-path operation for an in-coverage remote UE, i.e., a remote UE is enabled to use both a direct path and an indirect path simultaneously. Therefore, it is possible to have additional benefits including for example service continuity by reducing path switching interruptions multi-path in UE-to-NW relay.

Although it was already proposed to support the multi-path operation, there are still pending issues about different aspects of the multi-path operations, including, for example, the path adding, releasing, multi-path configuration, failure recovery, etc.

Embodiments of the present disclosure propose a solution for multi-path operation. In this solution, a processor of UE configured to perform multi-path operations. The operations includes transmitting to a base station a measurement report on a first path between the UE and the base station, wherein the measurement report indicates channel quality information on one or more potential paths between the UE and the base station. The operations also include receiving a path addition command from the base station, wherein the path addition command instructs the UE to add a path from one or more potential paths as a second path. The operations further include establishing the second path between the UE and the base station based on the path addition command.

According to embodiments of the present disclosure, the UE receives a path addition command from the base station and establishing the second path based on the path addition command. In such way, the UE can add another path between the UE and the BS and thus the multi-path operation can be implemented, thereby enhancing reliability and throughput, service continuity.

Principle and implementations of the present disclosure will be described in detail below with reference to FIGS. 1-20.

FIG. 1 shows an example communication network 200 in which embodiments of the present disclosure can be implemented. In network 200, the remote UE 210 is in coverage of BS 220 such as a gNB and can communicate with the BS 230 on the direct path 230 (i.e., Path 1) via NR Uu interface. Meanwhile, the remote UE 210 is assessable and controllable by the BS 220 on an indirect path 240 (Path 2) via the relay UE 230. In other words, the indirect path, includes the PC5 link between the remote UE 210 and the relay UE 230 via an end to end NR Uu interface and a direct radio link between the relay UE 210 and BS 220 via NR Uu interface. In such a way, the coverage of the BS is extended by multi-path operations.

It is to be understood that the number of UEs 210,230, BSs 220, and serving cells is only for the purpose of illustration without suggesting any limitations. The network 200 may include any suitable number of BSs, UEs and serving cells adapted for implementing embodiments of the present disclosure.

In the communication network 200, the BS 220 can communicate data and control information to the UE 210, 230, and the UE 210, 230 can also communication data and control information to the BS 220. A link from the BS 220 to the UE 210, 230 is referred to as a downlink (DL) or a forward link, while a link from the UE 210, 230 to the BS 220 is referred to as an uplink (UL) or a reverse link.

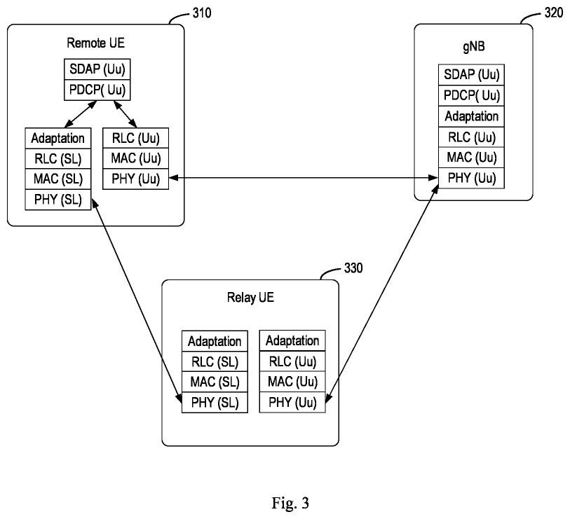

FIG. 3 illustrates a schematic diagram of multi-path architecture according to some embodiments of the present disclosure. As illustrated in FIG. 3, the multi-path architecture uses Packet Data Convergence Protocol (PDCP)-layer aggregation for both UL and DL.

In each of the remote UE 310, BS 320 such as gNB, the relay UE 330, they include a Service Data Adaption Protocol (SDAP) layer entity, a PDCP layer entity, a Radio Link Control (RLC) layer entity, a Media Access Control (MAC) layer entity, a Physical (PHY) layer entity for Uu interface, i.e., for direct link therebetween. The BS 320 further includes an adaption layer entity for PDCP-layer aggregation over the RLC (Uu) layer entity. Besides, the remote UE 310 and the Relay UE 330 further include an RLC layer entity, an MAC layer entity, a PHY layer entity for Sidelink interface, i.e., for indirect link therebetween and an adaption layer entity over the RLC layer entity for PDCP-layer aggregation.

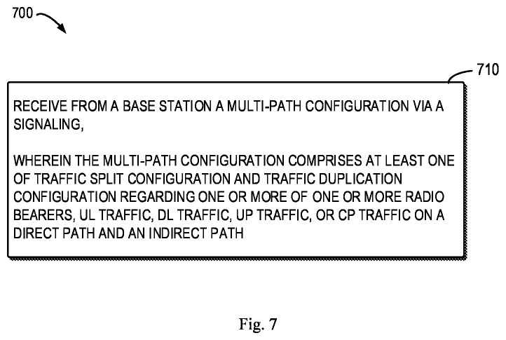

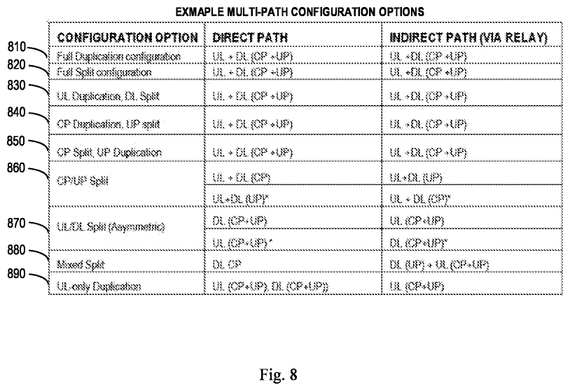

In addition, it is to be noted that Physical Layer (L1) aggregation like carrier aggregation (CA) is also possible. Compared to PDCP-layer aggregation, L1 aggregation might not be compatible with the existing solution (such as Rel-17 work) and would have impact of RAN1 work. Further, it is possible to also consider only use UL traffic for multi-path, i.e. an asymmetric multi-path, which will be detailed with reference to FIG. 7 to 8 hereinafter.

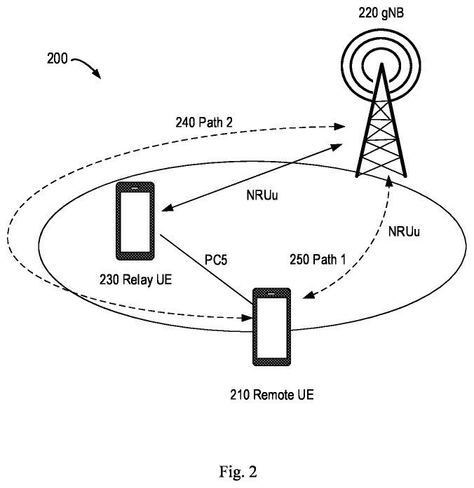

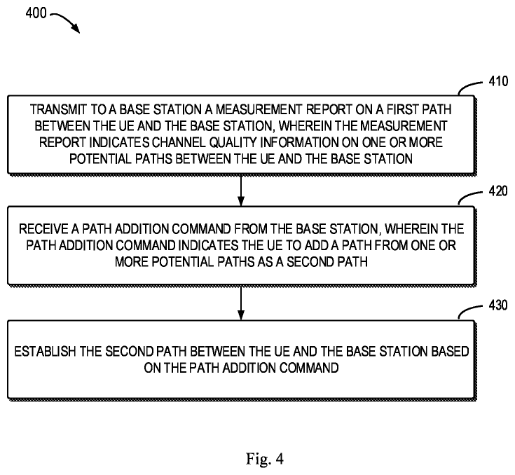

Based on for example the above multi-path architecture, it is possible to implement the multi-path operations. FIG. 4 shows a flowchart of a method of path adding in multi-path operations at a UE side according to some embodiments of the present disclosure. The method 400 can be implemented at a device, for example the remote UE 210 shown in FIG. 2. It is to be understood that the method 400 are given only for illustration purposes and the present disclosure is not limited thereto. The method 400 may include additional blocks not shown and/or may omit some shown blocks, and the scope of the present disclosure is not limited in this regard.

At block 410, the UE 210 transmits to a base station a measurement report on a first path between the UE and the base station. The measurement report indicates channel quality information on one or more potential paths between the UE and the base station. The measurement report may be transmitted to the BS 220 via for example Radio Resource Control (RRC) signaling, such as a RRC signaling “measurementReports.” Based on the measurement report, the BS 220 may determine a second path to be added from the one or more potential paths by considering for example, relay UE load, relay UE RRC state, etc., and send a path addition command to the UE 210.

At block 420, the UE 210 receives a path addition command from the base station, wherein the path addition command instructs the UE to add a path from one or more potential paths as a second path. The path addition command may be received via for example a RRC signaling. The RRC signaling could be for example RRCReconfiguraton with the desired configuration option. The path addition command may incudes for example multi-path configurations which are to be described with references to FIGS. 7 to 8 herein after. The path addition command may also indicate the target relay for the indirect path if the indirect is to be added.

At block 430, the UE 210 establishes the second path between the UE and the base station based on the path addition command.

In some embodiment, the second path is a direct path. In such embodiments, the second path is established by transmitting a random access channel (RACH) request to the base station; receiving a RACH response from the base station; and applying a corresponding multi-path configuration.

In some embodiments, resources for the RACH can be contained in common RACH configuration of system information block (SIB). The UE 210 may further receive a common RACH configuration in system information block and obtain the resources for the RACH from the common RACH configuration.

In some embodiments, resources for the RACH can be contained in a dedicated RRC signaling. The UE 210 may further receive a dedicated RRC signaling and obtain the resources for the RACH from the dedicated RRC signaling.

In some embodiments, the second path is an indirect path. In the method 400 the UE 210 may further discover one or more potential relay UEs for indirect paths; and performing channel measurements on the one or more potential relay UEs. In those embodiments, the path addition command may indicate a target relay UE for the second path and the establishing the second path may further comprise: establishing a link between the UE and the target relay UE.

In some embodiments, the UE 210 may further transmit, after the second path is established, a path addition confirmation to the base station. The path addition confirmation may be transmitted to the BS via a RRC signaling. The RRC signaling may include RRCReconfigurationComplete message. The path addition confirmation is transmitted on the first path (i.e., the old path) and the second path (i.e. the new path). In addition, it is also possible to transmit the path addition confirmation on both of the first and second path.

In some embodiments, the UE 210 may further transmit UE's capability information to the base station, wherein the UE's capability information indicates whether the UE supports multi-path sidelink relay or not. The UE's capability information can be reported via for example a RRC signaling.

In some embodiments, the UE 210 may further transmit a user preference for at least one of path adding or path removing via RRC signaling. Alternatively or additionally, the UE 210 may further transmit information on intention on path setup or path release. The information on intention can be contained within using UEAssistacneInformation (UAI) or SidelinkUEInformationNR.

The transmission of UAI message can be controlled by a prohibitive timer. The UAI message is transmitted when the prohibitive timer expires and the timer may be restarted after the UAI message is transmitted. When SL relay and NR-DC are simultaneously configured, the UAI can be used to indicate the removal of indirect path and SCG together

Therefore, in the above embodiments, the serving BS 220 controls the path setup for RRC_CONNECTED UE. The setup procedure is an “addition of path” procedure on the basis of for example an existing Uu RRC connection.

For an RRC_IDLE/remote UE or Out-Of-Coverage (OOC) UE, it needs establishing one path (the direct path without a relay or the indirect path with a relay) first.

For an RRC_INACTIVE UE, multi-path configurations are not useful. However, multi-path configurations can be part of UE context and stored in RRC_INACTIVE state.

When the RRC_INACTIVE UE resumes, the multi-path configuration may automatically restored without explicit configuration.

The one down-side to using the previously stored multi-path configuration is that UE still has to evaluate which of the links are still good enough to be resumed.

In some embodiments, the BS could configure the UE a quantitive threshold for cell quality. The UE could restore/resume the direct path first if the cell quality is higher than the threshold; or restore/resume the indirect path first if the cell quality is lower than the threshold.

In some embodiments, if the UE is still connected to the same relay UE when the UE resumes, the resume indirect path first. In some embodiments, if UE resumes to a different BS such as a gNB, both UE and NW can automatically drop the indirect path from the UE context.

In some embodiments is if a UE INACTIVE context only has a single path, then UE will continue to use that path when it resumes.

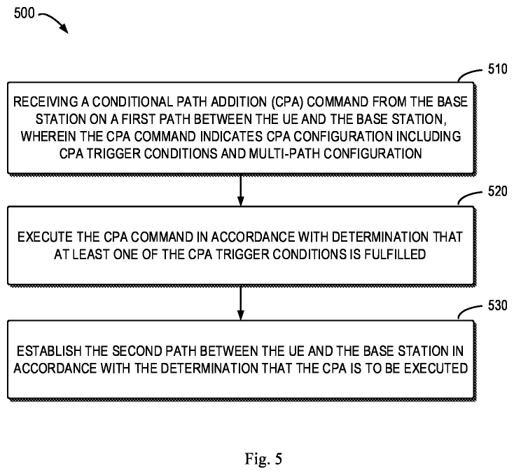

FIG. 5 illustrates a flowchart of a method of conditional path adding (CPA) in multi-path operations at a UE side according to some embodiments of the present disclosure. The method 500 can be implemented at a device, for example the remote UE 210 shown in FIG. 2. It is to be understood that the method 500 are given only for illustration purposes and the present disclosure is not limited thereto. The method 500 may include additional blocks not shown and/or may omit some shown blocks, and the scope of the present disclosure is not limited in this regard.

At block 510, the remote UE 210 receives a conditional path addition (CPA) command from the base station on a first path between the UE and the base station, wherein the CPA command indicates CPA configuration containing CPA trigger conditions and multi-path configuration.

Conditional handover (CHO) and Conditional PSCell Addition/Change (CPAC) are used in NR to enhance mobility. In present disclosure, it is proposed to consider Conditional Path Addition (CPA) for SL relay case. In some embodiments, the BS 220, i.e., the serving gNB, configure the CPA conditions and/or candidates in CPA command (e.g., RRCReconfiguration), before the CPA operation is performed.

In some embodiments, for direct path addition, the signaling design can be forward-compatible with inter-gNB case. In such a case, the remote UE 210 is configured with conditions and target cell (Multi-path) configurations per each target cell. For intra-gNB case, the remote UE 210 can only trigger to establish a path to the same gNB when the direct path addition is satisfied.

In some embodiments, for indirect path addition, the gNB 220 may specify multiple candidate relay UEs. In such a case, Corresponding conditions and configuration could be set per relay UE, but not limited thereto. The remote UE only conduct the path addition if the selected relay UE satisfies the upper layer criteria and the lower layer criteria indicated by gNB in CPA command.

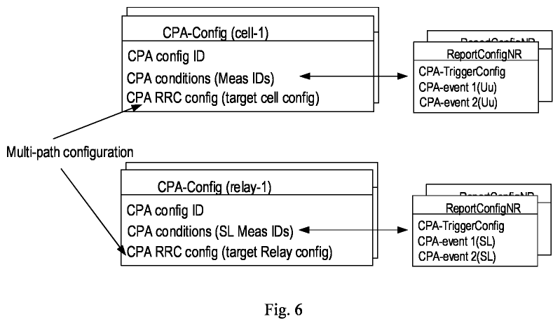

Reference is made to FIG. 6 which illustrates a schematic diagram of CPA configuration according to some embodiments of the present disclosure. As illustrated in FIG. 6, the CPA-configuration may include CPA-configuration list for direct CPA and indirect CPA.

The CPA-configuration list for the direct CPA includes one or more CPA configurations for one or more potential cells, for example CPA-Config (cell-1), CPA-Config (cell-2) . . . Each of the CPA configurations comprises CPA configuration ID, CPA conditions), and CPA RRC configuration. The CPA configuration ID identifies the CPA configuration. The CPA conditions indicate triggering conditions for CPA. The CPA conditions may a plurality of CPA Trigger configuration including one or more CPA event which is used to trigger the CPA. The CPA RRC configuration may include the configurations related to the target cell. For the event-triggers defined for adding a direct path, those events are associated with the Uu interface measurement identifiers, as shown in FIG. 6. Each measurement identifier corresponds a condition for which the path addition command to add the direct path can be triggered to be executed.

The CPA-configuration list for the indirect CPA has similar design. The difference lies in that the CPA-configuration is related to relay UEs, the CPA conditions are related to SL and the CPA RRC configuration is related to target relays. The CPA RRC configurations may include the multi-path configuration, for example, those to be described in details with reference to FIGS. 7 to 8 hereinafter, or other different configurations. For the event-triggers defined for adding an indirect path, those events are associated with the Sidelink interface measurement identifiers, as shown in FIG. 6. Each measurement identifier corresponds a condition for which the path addition command to add the indirect path (i.e., via the SL relay) can be triggered to be executed.

In some embodiments, trigger conditions are defined as CPA event triggers for example in ReportConmfigNR. Alternatively or additionally, the multi-path configuration can be per target cell or target relay or be common (outside of each CPA configuration list).

In some embodiments, the multi-path configuration and the trigger conditions/events can be also transmitted to the UE 210 in two different signaling.

In some embodiments, the UE 210 transmits a CPA command acknowledgement to the base station on the first path. The CPA command acknowledgement can be transmitted to the BS 220 via a RRC signaling. Alternatively, the acknowledgement can be conveyed implicitly by lower layer mechanisms (e.g., RLC Status PDU, or HARQ ACK) instead of using a dedicated RRC message.

In some embodiments, the UE 210 may further transmit UE's capability information to the base station before receiving the CPA command, wherein the UE's capability information indicates whether the UE supports multi-path sidelink relay or not. The UE's capability information can be reported via for example a RRC signaling.

In some embodiments, the UE 210 may further transmit a user preference for at least one of path adding or path removing via RRC signaling. Alternatively or additionally, the UE 210 may further transmit information on intention on path setup or path release. The information on intention can be contained within using UEAssistanceInformation (UAI) or SidelinkUEInformationNR.

In some embodiments, the UE 210 may transmit to a base station a measurement report on a first path between the UE and the base station. The measurement report indicates channel quality information on one or more potential paths between the UE and the base station. The measurement report may be transmitted to the BS 220 via for example Radio Resource Control (RRC) signaling, such as a RRC signaling “measurementReports.” Based on the measurement report, the BS 220 may determine CPA conditions and multi-path configuration, and send a path addition command to the UE 210.

Reference is made back to FIG. 5, at block 520, the UE 210 executing the CPA command in accordance with determination that at least one of the CPA trigger conditions is fulfilled. In response to the CPA command, the UE monitors the potential candidate cells or candidate relay UE and determines whether any of the CPA conditions is met. If it is met, the UE 210 will trigger the CPA; if not, the UE will keep monitor the candidate relay UEs or candidate cells or BSs.

In some embodiments, the determination that at least one of the CPA trigger conditions is fulfilled is made based on measurement result of any candidate cell or candidate relay UE meets event threshold(s) relating to measurement identifier for its corresponding path.

At block 530, the UE 210 establishes the second path between the UE and the base station in accordance with the determination that the CPA is triggered.

If any of the CPA conditions is met, the UE 210 begins the establishment of the second path. In some embodiments, the second path is a direct path and the second path is establishing by means a random access channel (RACH) procedure. For example, the UE 210 first transmits an RACH request to the base station; and then receives a RACH response from the base station. Then the UE 210 applies applying a corresponding multi-path configuration.

In some embodiments, resources for the RACH can be contained in common RACH configuration of system information block (SIB). The UE 210 may further receive a common RACH configuration in system information block and obtain the resources for the RACH from the common RACH configuration.

In some embodiments, resources for the RACH can be contained in a dedicated RRC signaling. The UE 210 may further receiving a dedicated RRC signaling and obtain the resources for the RACH from the dedicated RRC signaling.

In some embodiments, the second path is an indirect path. In the method 400, the UE 210 may further discover one or more potential relay UEs for indirect paths and perform channel measurements on the one or more potential relay UEs. In some embodiments, the UE 210 establishes the second path by establishing a link between the UE and the target relay UE.

In some embodiments, the UE 210 may further transmit a user preference for at least one of path adding or path removing via RRC signaling. Alternatively or additionally, the UE 210 may further transmit information on intention on path setup or path release. The information on intention can be contained within using UEAssistanceInformation (UAI) or SidelinkUEInformationNR. Similarly, the transmission of UAI message can be controlled by a prohibitive timer.

In some embodiment, the BS 220 may transmit a CPA revoke command to revoke the CPA command and the UE 210 may respond to a CPA revoke command to stop the CPA operations. Alternatively or additionally, the BS 220 may transmit a CPA reconfiguration command to change at least one of CPA conditions or CPA multi-path configuration and the UE 210 may change CPA conditions or CPA multi-path configuration, or according to the CPA reconfiguration command.

In some embodiments, the UE 210 may further transmit, after the second path is established, a path addition confirmation to the base station. The path addition confirmation may be transmitted to the BS via a RRC signaling. The RRC signaling may include RRCReconfigurationComplete message. The path addition confirmation is transmitted on the first path (i.e., the old path) and the second path (i.e. the new path). In addition, it is also possible to transmit the path addition confirmation on both of the first and second path.

In the above embodiments, the CPA command is transmitted to the UE 210 to specify the CPA configurations and thus the UE 210 could determine to trigger the CPA base on the CPA configuration. In this way, the CPA can be implemented, thereby enhancing the UE's mobility.

Hereinafter, further embodiments relating to the multi-path operations for the multi-path configuration, RRC_INACTIVE remote UE, CP procedure, UP procedure, link recovery, etc. will be described. It is to be noted that these embodiments can be applied to both the path addition and conditional path addition described above with FIGS. 4 to 6.

### Multi-Path Configuration

FIG. 7 illustrates a flowchart of a method of multi-path configuration at a UE side according to some embodiments of the present disclosure. The method 700 can be implemented at a device, for example the remote UE 210 shown in FIG. 2. It is to be understood that the method 700 are given only for illustration purposes and the present disclosure is not limited thereto. The method 700 may include additional blocks not shown and/or may omit some shown blocks, and the scope of the present disclosure is not limited in this regard.

At block 710, the remote UE 210 receives from a base station a multi-path configuration via a signaling. The multi-path configuration comprises at least one of traffic split configuration and traffic duplication configuration regarding one or more of one or more radio bearers, uplink (UL) traffic, downlink (DL) traffic, user plane (UP) traffic, or control plane (CP) traffic on a direct path and an indirect path. The base station may determine a proper multi-path configuration based on one or multiple factors, such as UE 210's path loss to the base station, UE 210's SL radio link quality towards the relay UE 230, latency requirements of traffic, reliability requirements of the traffic and load balancing considerations.

In some embodiments, the multi-path configuration comprises traffic split configuration and traffic duplication configuration can be for example per radio bearer. For user plane, the multi-path configuration can be per DRB, for control plane, the multi-path configuration can be per SRB.

In some embodiments, the multi-path configuration comprises one or more of: full duplication configuration, full split configuration, UL split and DL duplication configuration, CP duplication and UP split configuration, CP split and UP duplication configuration, CP/UP split configuration, UL/DL split configuration, mixed split configuration, or UL-only duplication configuration, For illustrative purposes, references will be made to FIG. 8 to describe some example multi-path configuration options.

FIG. 8 illustrates a schematic diagram of multi-path configuration options according to some embodiments of the present disclosure, wherein nine example multi-path configuration options are illustrated and each of them will be described as follows.

### Full Duplication Configuration

As illustrated by 810, the full duplication configuration means all traffic, regardless of UL traffic, DL traffic, CP traffic or UP traffic, will be duplicated on a direct path and an indirect path. Therefore, any traffic from or to the UE 210 will be duplicated and transmitted on the direct path and the indirect path simultaneously.

### Full Split Configuration

As illustrated by 820, for the full split configuration, all traffic, regardless of UL traffic, DL traffic, CP traffic or UP traffic, will be split on a direct path and an indirect path. Therefore any traffic from or to the UE 210 will be split and transmitted on the direct path and the indirect path separately.

### UL Split and DL Duplication Configuration

As illustrated by 830, for the UL split and DL duplication configuration, the UL traffic will be split on a direct path and an indirect path while the UL traffic will be duplicated on a direct path and an indirect path. Therefore, UL traffic and Dl traffic have different split/duplication configuration.

### CP Duplication and UP Split Configuration

As illustrated by 840, for the CP duplication and UP split configuration, CP traffic will be duplicated on a direct path and an indirect path while UP traffic will be split on a direct path and an indirect path and. Therefore, CP traffic and UP traffic have different split/duplication configuration.

### CP Split and UP Duplication Configuration

As illustrated by 850, for CP split and UP duplication configuration, CP traffic will be split on a direct path and an indirect path while UP traffic will be duplicated on a direct path and an indirect path. This configuration is similar to CP Duplication and UP Split Configuration but CP traffic using split configuration and the UP traffic use duplication configuration.

### CP/UP Split Configuration

As illustrated by 860, for CP/UP split configuration, CP traffic and UP traffic will be split on a direct path and an indirect path. For example, the CP traffic can only be conducted on the direct path and the UP traffic can only be conducted on the indirect path; as another example, the CP traffic can only be conducted on the indirect path and the UP traffic can only be conducted on the direct path.

### UL/DL Split Configuration (Asymmetric)

As illustrated by 870, for UL/DL split configuration, the UL traffic and DL traffic will be split on a direct path and an indirect path. For example, the DL traffic can be conducted only on the direct path and the UL traffic can only be conducted only on the indirect path; as another example, the DL traffic can only be conducted on the indirect path and the UL traffic can only be conducted on the direct path.

### Mixed Split Configuration

As illustrated by 880, for mixed split configuration, in one of DL and UL traffic, CP traffic and UP traffic will be split on a direct path and an indirect path. For example, CP traffic on DL can only be conducted on the direct path and UP traffic on DL can be conducted on the direct path; meanwhile UL traffic can be conducted only on the indirect path.

### UL-Only Duplication Configuration

As illustrated by 890, in UL-only duplication configuration, only UL traffic is duplicated on a direct path and an indirect path and DL traffic can only be conducted on the direct path.

It is to be noted that the above configuration options are only for illustrative purposes and other options are also possible. In fact, it is ideal if each PDCP bearer (Signaling Resource Block (SRB)/Date Resource Block (DRB)) can be configured respectively as duplicate or split in two paths. The granularity of configuration may be per radio bearer. Generally, the SRB2 and DRB can be configurable, but SRB0 or SRB1 needs to follow some specific rules which limits its options to be used in one of the path.

In addition to overhead advantageous, split could further provide further merits. For example, for CP procedure, direct path will help to mitigate security/privacy concern about UE identity leak. In addition, UL/DL split enables using the relay to mitigate the UL path-loss issue.

Besides, there might be some special split configurations. In some embodiments, a direct path is just used for a relay procedure not transparent to the relay UE. In such way, the configuration could keep the relay UE operation relatively simple. For example, any of paging message transmission and system information transmission can only use direct path; all other CP messages can use indirect path or use both paths.

It is to be noted that the multi-path configurations can be applicable for both the path addition and the conditional path addition described above with reference FIGS. 4 to 6. for the method described with FIG. 4 can be only applicable when both paths are available (e.g., no RLF occurs). Before the multi-paths are established, the UE 210 may follow Rel-17 single path operations via relay or just use direct Uu interface. Besides, after multi-path is established, some of the message transportation may be moved to the newly-added path.

### Multi-Path Operations for RRC INACTIVE Remote UE

It can be understood that the multi-path configurations might not useful for UE in an RRC-inactive state. However, in some embodiments, the UE may still store the multi-path configuration as a part of UE context in RRC-inactive state. Thus, when the UE resumes, the multi-path configuration may automatically restored without explicit configuration. In such case, the UE would have to evaluate which of the links are still good enough to be resumed. This evaluation can be made based cell quality or whether the same relay is connected after the resumption.

In some embodiments, a quantitive threshold for cell quality is pre-configured and the UE 210 could determine to restore/resume the direct path first if the cell quality is higher than the threshold; or determine to restore/resume the indirect path first if the cell quality is lower than the threshold.

In some embodiments, if UE is still connected to the same relay UE when UE resumes, the UE may determine to resume indirect path first. On the other hand, if UE resumes to a different gNB, both the UE and the BS can automatically drop the indirect path. In addition, if UE INACTIVE context only has a single path, then UE 210 will continue to use that path when it resumes.

In some embodiments, the BS 220 may initiate a path release procedure for a multi-path remote UE. For example, a two-way handshake procedure may be used, wherein the BS such as gNB sends the path release command, the UE release the path and sends back a response. After the path release, the UE may remain in RRC_CONNECTED state. In addition, the BS 220 may combine this with a RRCRelease message and put the UE in RRC_INACTIVE. In this case, the RRC_INACTIVE UE will only have one path in its UE INACTIVE Context.

### Multi-Path Operation for CP Procedure

In some embodiments, for CPA, when it has not been executed, the gNB may use RRC signaling to revoke the CPA or change the configuration or conditions.

In some embodiments, the multi-path release can also be triggered by the UE through a path release request or indication. The UE 210 may determine to release a path based on path measurements, and send UAI to indicate the path release.

In some embodiments, after the multi-path including a direct path and an indirect path is established, the UE 210 may designate the direct path as the primary path, and designate indirect path as a secondary path, no matter which path is setup first. The primary path can be used for sending and receiving MAC CE (e.g., to suspend/resume indirect path or control traffic split ratio). In addition, the UE 210 may be configured to designate a primary path for essential operations only, including for example, paging, SI.

In some embodiments, the UE 210 may be configured to always remove secondary path first, when multi-path is no longer needed. Additionally or alternatively, the UE 210 may be confirmed to start all follow-up CP procedure with a first signaling in the primary path.

For UE 210 to initiate the setup of indirect path based on gNB configuration or a CPA command, the UE choose TX resource based on the SL resource configuration (e.g., common TX resource pool) provided by the serving cell of the UE. In some embodiments, the base station may include a “SL-ConfigDedicated” IE in the dedicated RRC message (e.g., path addition command or conditional path addition (CPA) command) to allow the remote UE to use Sidelink mode 1 resource allocation, including dynamic grant (DG) or configured grant (CG).

### Multi-Path Operation for UP Solution

For the PDCP data split/aggregation over multi-path connections, no additional fields needed in user plane protocols.

In some embodiments, traffic from indirect path may be mapped to the end-to-end Uu DRB with the information in adaptation layer (PC5 or Uu) header and then be passed up to the PDCP entity. Regarding traffic from direct path, they could be first processed by PDCP entity directly when direct RLC bearer is mapped to the Uu DRB.

In some embodiments, either the UE 210 or the BS 220 such as gNB can determine whether the traffic is duplicated by checking PDCP SN.

In some embodiments, the network may control traffic splitting at PDCP layer. This can be similar to direct connection mechanism, which can be implemented by the UE. Alternatively or additionally, it is possible to specify the traffic split percentage among the paths. When the UE 210 operates in the multi-path mode, The network may need to adjust this traffic split ratio from time to time for a particular DRB from time to time (e.g., based on QoS requirements of the Uu DRB and the corresponding measurements). The network can use MAC CE to adjust the traffic split configuration or other UE scheduling parameters. For example, the MAC CE can be sent in the direct path to control the split ratio of the UL traffic.

In some embodiments, a “suspending” state or dormant state is introduced for the indirect path or the secondary path. Thus, the traffic in the indirect path or secondary path can be paused/resumed. In the suspend state, the indirect path (e.g., PC5 link) is still measured and maintained. For example, the path is still used to transport some minimal “dummy” traffic, such as a “keep-alive” message so that the measurements can be still collected. In such a way, the indirect path can be re-activated without any issue. In addition, it is possible to use a MAC CE in the direct path to enable the resumption/suspending operation of the indirect path.

### Link Recovery Enhancements

With multi-path (e.g., dual-path in SL relay) configuration, the link failure can be reported to the NW via the alternative path. In this case, UE may be configured to conduct RRC-reestablishment (legacy) or wait for NW command. The UE 210 may inform the BS 220 of direct path issues via the SL relay and of SL relay issues via the direct path to gNB.

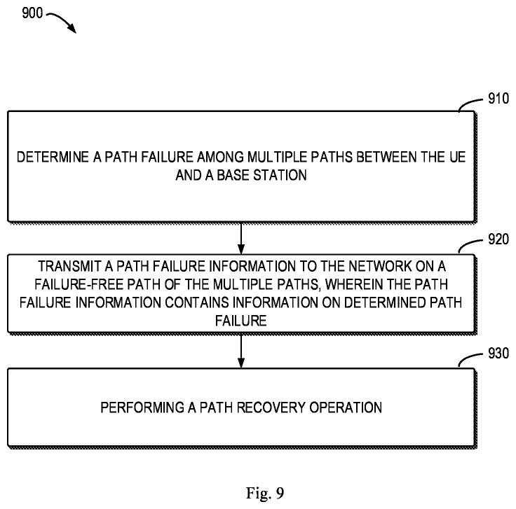

FIG. 9 illustrates a flowchart of a method of failure path recovery at a UE side according to some embodiments of the present disclosure. The method 900 can be implemented at a device, for example the remote UE 210 shown in FIG. 2. It is to be understood that the method 900 are given only for illustration purposes and the present disclosure is not limited thereto. The method 900 may include additional blocks not shown and/or may omit some shown blocks, and the scope of the present disclosure is not limited in this regard.

At block 910, the UE 210 determines a path failure among multiple paths between the UE and a base station.

In some embodiments, the failed path could be the direct path and in such a case, the UE 210 could monitor the direct path and detect the direct path failure between the UE and a base station.

In some embodiments, the failed path could be the indirect path. If the failed path is the link between the UE 210 and relay UE 230, the UE 210 could monitor the link and detects the indirect path failure between the UE and relay UE. If the link between the relay UE 230 and the BS 220 fails, the relay UE 230 will send a failure indication to the remote UE 210. Therefore, the UE 210 may determine the indirect path failure base on receiving a failure indication from relay UE.

At block 920, the UE 210 transmits path failure information to the network device such as the BS 220 on a failure-free path of the multiple paths, wherein the path failure information contains information on determined path failure.

At block 930, the UE 210 performs a path recovery operation. In some embodiments, the UE may perform an RRC-reestablishment operation like those in the legacy solution. Alternatively, the UE may receive a path recovery command from the base station, wherein the path recovery command instructs the UE to establish a new indirect path via another UE or to handover to another cell.

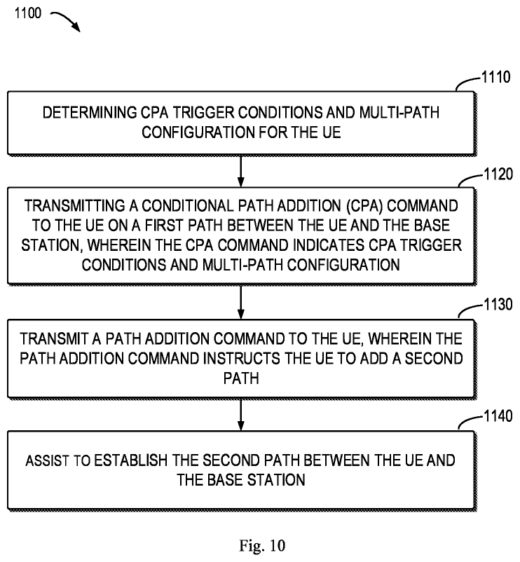

FIG. 10 illustrates a flowchart of a method of path adding in multi-path operations at a BS side according to some embodiments of the present disclosure. The method 1000 can be implemented at a device, for example the BS 210 like gNB shown in FIG. 2. It is to be understood that the method 1000 are given only for illustration purposes and the present disclosure is not limited thereto. The method 1000 may include additional blocks not shown and/or may omit some shown blocks, and the scope of the present disclosure is not limited in this regard.

At block 1010, the BS 220 receives from user equipment (UE) a measurement report on a first path between the UE and the base station, wherein the measurement report indicates channel quality information on one or more potential paths between the UE and the base station. The measurement report may be transmitted to the BS 220 via for example Radio Resource Control (RRC) signaling, such as a RRC signaling “measurementReports.”

In some embodiments, the BS 220 may receive UE's capability information from the UE, for example before sending the measurement report. The UE's capability information indicates whether the UE supports multi-path sidelink relay or not.

In some embodiments, the BS 220 may further receive a user preference for at least one of path adding or path removing via RRC signaling. Additionally, or alternatively, the BS 220 may further receive an intention on path setup or path release in UEAssistanceInformation or SidelinkUEInformationNR.

At block 1020, the BS 220 determines a second path to be added from the one or more potential paths based on the measurement report. Based on the measurement report, the BS 220 may determine a second path to be added by considering for example, relay UE load, relay UE RRC state, etc., and send a path addition command to the UE 210. The path addition command may be transmitted via for example a RRC signaling. The RRC signaling could be for example RRCReconfiguraton with the desired configuration option.

At block 1030, the BS 220 transmits a path addition command to the UE, wherein the path addition command indicates the UE to add a second path.

In some embodiment, the BS 220 may further receive a path addition confirmation from the UE, wherein the path addition confirmation is received on one or both of the first path and the second path.

At block 1004, the BS 220 assists to establish the new path between the UE and the base station.

In some embodiment, the second path is a direct path. In such embodiments, the BS 220 may receive a random access channel (RACH) request from the UE 210 and transmitting a RACH response to the UE 210.

In some embodiments, resources for the RACH can be contained in common RACH configuration of system information block (SIB). The BS 220 may transmit a common RACH configuration in system information block to the UE 210.

In some embodiments, resources for the RACH can be contained in a dedicated RRC signaling. The BS 220 may further transmit a dedicated RRC signaling and obtain the resources for the RACH from the dedicated RRC signaling.

In some embodiments, the second path is an indirect path, the path addition command indicates a target relay UE for the second path; and the BS 220 may further establish a link between the target relay UE and the base station. The establishing a link between the target relay UE and the base station may be initiated by the BS 220. Alternatively, The establishing a link between the target relay UE and the base station may be initiated by the UE.

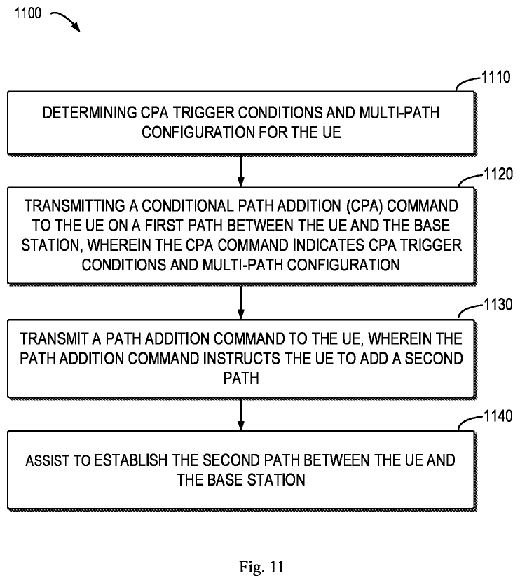

FIG. 11 illustrates a flowchart of a method of conditional path adding in multi-path operations at a BS side according to some embodiments of the present disclosure. The method 1100 can be implemented at a device, for example the BS 210 like gNB shown in FIG. 2. It is to be understood that the method 1100 are given only for illustration purposes and the present disclosure is not limited thereto. The method 1100 may include additional blocks not shown and/or may omit some shown blocks, and the scope of the present disclosure is not limited in this regard.

At block 1110, the BS 220 determines CPA trigger conditions and multi-path configuration for the UE 210. Example CPA triggering conditions/events and multi-path configuration are already described with reference to FIGS. 5 to 6 and 7 to 8 and thus details thereof will be omitted herein.

In some embodiments, the BS 220 may further receive UE's capability information from the UE, wherein the UE's capability information indicates whether the UE supports multi-path sidelink relay or not;

In some embodiments, the BS 220 may further receive a measurement report on a first path between the UE and the base station from the UE, wherein the measurement report indicates channel quality information on one or more potential paths between the UE and the base station. The CPA triggering conditions/events and multi-path configuration may be determined based thereon.

In some embodiments, the BS 220 may further receive a user preference for at least one of path adding or path removing via RRC signaling for example before the determination of the CPA conditions and the multi-path configuration.

In some embodiments, the BS 220 may further receive an intention on path setup or path release in UEAssistacneInformation or SidelinkUEInformaitonNR for example before the determination of the CPA conditions and the multi-path configuration.

At block 1120, the BS 220 transmits a CPA command from the base station on a first path between the UE and the base station, wherein the CPA command indicates a CPA configuration including CPA trigger conditions and multi-path configuration. In some embodiments, the CPA configuration may be per each target call or per each relay UE.

In some embodiments, the BS 220, i.e., the serving gNB, configure the CPA conditions and/or candidates in the CPA command (e.g., RRCReconfiguration), before the CPA operation is performed.

In some embodiments, the BS 220 may further receive a CPA command acknowledgement from the UE on the first path.

At block 1130, the BS 220 assist to establish a second path between the UE and the base station in response to the UE's request.

In some embodiments, the BS 220 may receive a path addition confirmation from the UE, for example via RRC. The path addition confirmation may be received on one or both of the first path and the second path.

In some embodiments, the second path is a direct path and in such a case the BS 220 may establish the second path by receiving a random access channel (RACH) request from the UE and transmitting a RACH response to the UE.

In some embodiments, resources for the RACH can be contained in common RACH configuration of system information block (SIB). The BS 220 may further transmit a common RACH configuration in system information block containing resources for the RACH from the dedicated RRC signaling.

In some embodiments, resources for the RACH can be contained in a dedicated RRC signaling. The BS 220 may further transmit a dedicated RRC signaling containing resources for the RACH from the dedicated RRC signaling.

In some embodiments, the second path is a direct path and the path addition command may indicate a target relay UE for the second path; and in such a case the BS 220 may establish the second path by establishing a link between the target relay UE and the base station.

In some embodiments, the establishing a link between the target relay UE and the base station may initiated by the BS 210 or by the UE.

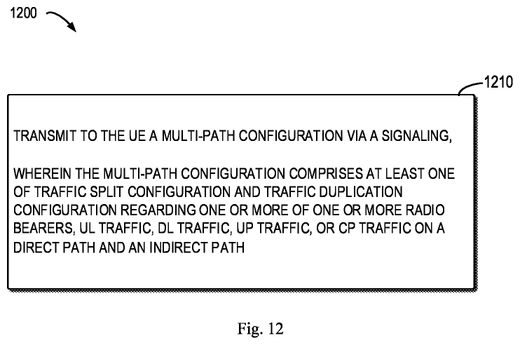

FIG. 12 illustrates a flowchart of a method of multi-path configuration at a BS side according to some embodiments of the present disclosure. The method 1200 can be implemented at a device, for example the BS 210 like gNB shown in FIG. 2. It is to be understood that the method 1200 are given only for illustration purposes and the present disclosure is not limited thereto. The method 1200 may include additional blocks not shown and/or may omit some shown blocks, and the scope of the present disclosure is not limited in this regard.

At block 1210, the BS 220 transmits to the UE 210 a multi-path configuration via a signaling. The multi-path configuration may comprise at least on of traffic split configuration and traffic duplication configuration regarding one or more of one or more radio bearers, uplink (UL) traffic, downlink (DL) traffic, user plane (UP) traffic, or control plane (CP) traffic.

In some embodiments, the multi-path configuration comprises traffic split configuration and traffic duplication configuration can be for example per radio bearer. For user plane, the multi-path configuration can be per DRB, for control plane, the multi-path configuration can be per SRB.

In some embodiments, the multi-path configuration may comprise one or more of: full duplication configuration, full split configuration, UL split and DL duplication configuration, CP duplication and UP split configuration, CP split and UP duplication configuration, CP/UP split configuration, UL/DL split configuration, mixed split configuration, or UL-only duplication configuration.

Particularly, in the full duplication configuration, all traffic is duplicated on a direct path and an indirect path. In the full split configuration, wherein all traffic is split on a direct path and an indirect path. In the UL split and DL duplication configuration, UL traffic is split on a direct path and an indirect path and UL traffic is duplicated on a direct path and an indirect path. In the CP duplication and UP split configuration, CP traffic is duplicated on a direct path and an indirect path and UP traffic is split on a direct path and an indirect path and. In the CP split and UP duplication configuration, CP traffic is split on a direct path and an indirect path and UP traffic is duplicated on a direct path and an indirect path. In the CP/UP split configuration, CP traffic and UP traffic are split on a direct path and an indirect path. In the UL/DL split configuration, UL traffic and DL traffic are split on a direct path and an indirect path. In mixed split configuration, for one of DL and UL traffic, CP traffic and UP traffic are split on a direct path and an indirect path. In the UL-only duplication configuration, only UL traffic is duplicated on a direct path and an indirect path.

In some embodiment, the multi-path configuration is per radio bearer.

In some embodiment, the multi-path configuration, a direct path is used for a relay procedure not transparent to the relay UE, wherein the relay procedure includes at least one of paging message transmission and system information transmission.

In some embodiment, the BS 220 may transmit a CPA revoke command to revoke the CPA command and the UE 210 may respond to a CPA revoke command to stop the CPA operations. Alternatively or additionally, the BS 220 may transmit a CPA reconfiguration command to change at least one of CPA conditions or CPA multi-path configuration and the UE 210 may change CPA conditions or CPA multi-path configuration, or according to the a CPA reconfiguration command.

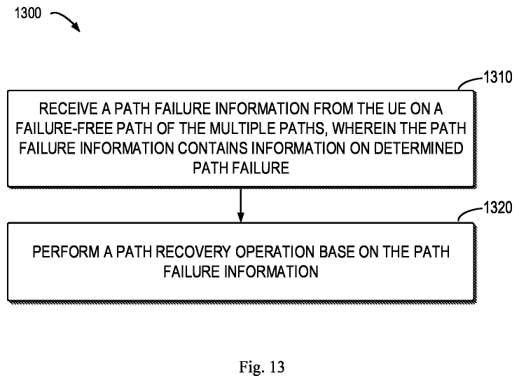

FIG. 13 illustrates a flowchart of a method of failure path recovery at a BS side according to some embodiments of the present disclosure. The method 1300 can be implemented at a device, for example the BS 210 like gNB shown in FIG. 2. It is to be understood that the method 1000 are given only for illustration purposes and the present disclosure is not limited thereto. The method 1300 may include additional blocks not shown and/or may omit some shown blocks, and the scope of the present disclosure is not limited in this regard.

At block 1310, the BS 210 receives path failure information from the UE 210 on a failure-free path of multiple paths, wherein the path failure information contains information on determined path failure.

At block 1320, the BS 210 performs a path recovery operation based on the path failure information. In some embodiments, the UE may perform an RRC-reestablishment operation like those in the legacy solution. Alternatively, the BS 220 may transmit a path recovery command to the UE, wherein the path recovery command instructs the UE to establish a new indirect path via another UE or to handover to another cell.

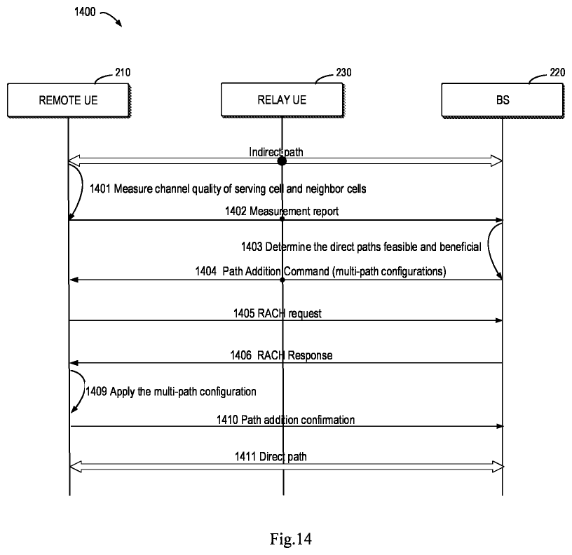

For illustrative purposes, FIGS. 14 to 19 illustrate signaling flows of multi-path operations according to some embodiments of the present disclosure. Hereinafter, reference will be made to these figures to describe these embodiments.

FIG. 14 illustrates a signaling chart of a method of direct path adding in multi-path operations according to some embodiments of the present disclosure. It is to be understood that the signaling chart 1400 are given only for illustration purposes and the present disclosure is not limited thereto. The signaling chart 1400 may include additional operations or signaling not shown and/or may omit some shown blocks, and the scope of the present disclosure is not limited in this regard.

As illustrated, at the beginning of the flow chart, there was already an indirect path. At 1401, the UE 210 measures channel quality of serving cell and neighboring cells. At 1402, the UE 210 sends a measurement report related to channel quality information on the serving and neighboring cells to the BS 210 on the indirect path via the relay UE 230. At 1403, the BS 220 determines which direct path can be added based on for example the measurement report and sends a path addition command indicating the multi-path configurations to the UE 210 at 1404. The multi-path configurations are already described with reference to FIGS. 7 to 8 and thus the detailed description will be omitted herein. After the UE 210 receives the path addition command, it sends a RACH request at 1405 directly to the BS 220 using the resource obtained from common RACH configuration of SIB or a dedicated RRC signaling. At 1406, the UE 210 receives RACH response from the BS 220 and applies the multi-path configuration at 1409. Thereafter, a path addition confirmation can be further fed back to the BS 220 via the direct path at 1410. Then, at 1411, the UE begin communication with the BS on the newly added direct path.

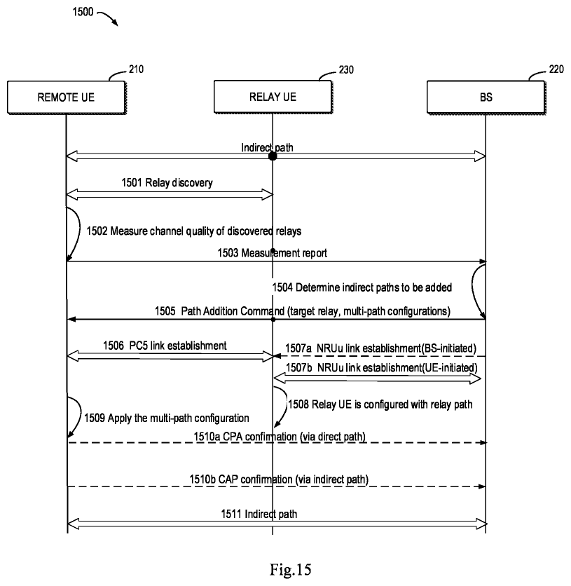

FIG. 15 illustrates a signaling chart of a method of indirect path adding in multi-path operations according to some embodiments of the present disclosure. It is to be understood that the signaling chart 1500 are given only for illustration purposes and the present disclosure is not limited thereto. The signaling chart 1500 may include additional operations or signaling not shown and/or may omit some shown blocks, and the scope of the present disclosure is not limited in this regard.

As illustrated, at the beginning of the flow chart, there was already a direct path. At 1501, the UE first conducts a relay discovery operation to discover potential relay UEs. At 1502, the UE 210 measures channel quality of the discovered relay UEs. At 1503, the UE 210 sends a measurement report related to channel quality information on the discovered relay UEs to the BS 210 on the direct path. At 1504, the BS 220 determines which indirect path can be added based on for example the measurement report and sends a path addition command indicating target relay and multi-path configurations to the UE 210 at 1505. The multi-path configurations which are already described with reference to FIGS. 7 to 8 and thus the detailed description will be omitted herein. After the UE 210 receives the path addition command, the UE establishes a PC 5 link with the relay UE at 1506 and the NR Uu link between the relay UE 230 and the BS 220 is established at 1507a, or 1507b. The establishment of NR Uu link between the relay UE 230 and the BS 220 can be initiated by the BS 210 (1507a) or by the UE (1507b). Thus, the relay UE is configured as a relay UE for the UE 210 at 1508. After the indirect path is established, the UE 210 applies the multi-path configuration at 1509. Thereafter, a path addition confirmation can be further fed back to the BS 220 via one or both of the direct path and the indirect path, at 1510a, 1510b. Then, at 1511, the UE begin communication with the BS on the newly added indirect path.

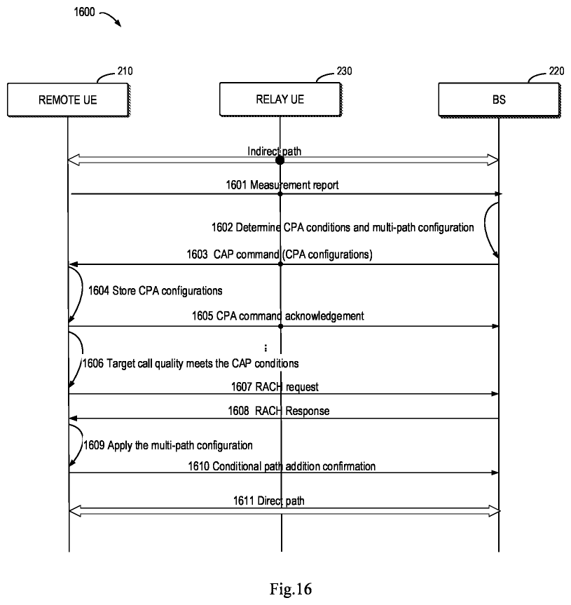

FIG. 16 illustrates a signaling chart of a method of conditional direct path adding in multi-path operations according to some embodiments of the present disclosure. It is to be understood that the signaling chart 1600 are given only for illustration purposes and the present disclosure is not limited thereto. The signaling chart 1600 may include additional operations or signaling not shown and/or may omit some shown blocks, and the scope of the present disclosure is not limited in this regard.

As illustrated, at the beginning of the flow chart, there was already an indirect path. At 1601, the UE 210 measures channel quality of serving cell and neighboring cells and sends a measurement report related to channel quality information on the serving and neighboring cells to the BS 210 on the indirect path via the relay UE 230. At 1602, the BS 220 determines CAP conditions and multi-path configurations based on for example the measurement report. At 1603 the BS 220 sends a path addition command indicating the CPA configuration including CPA conditions and multi-path configurations to the UE 210. The multi-path configurations are already described with reference to FIGS. 7 to 8 and thus the detailed description will be omitted herein. After the UE 210 receives the path addition command, it stores the CPA configurations at 1604 and sends a CPA command acknowledgement to the BS 220 at 1605. Then at 1606, the UE 210 conducts event evaluation to determine whether a new path shall be added. For example, the UE 210 may determine whether the target cell quality meets any of the CPA conditions. If it determines to add a new path, the UE 210 sends a RACH request at 1607 directly to the BS 220 using resource obtained from common RACH configuration of SIB or a dedicated RRC signaling. At 1608, the UE 210 receives RACH response from the BS 220 and applies the multi-path configuration at 1609. Thereafter, a path addition confirmation can be further fed back to the BS 220 via the direct path at 1610. Then, at 1611, the UE begin communication with the BS on the newly added direct path.

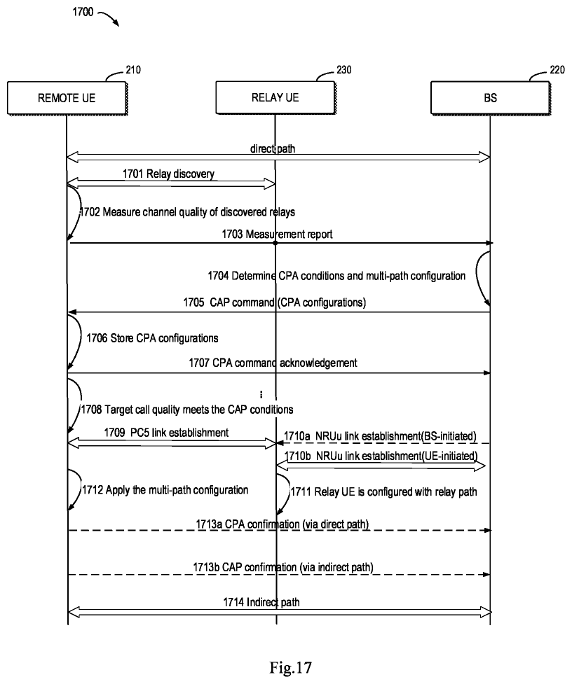

FIG. 17 illustrates a signaling chart of a method of conditional indirect path adding in multi-path operations according to some embodiments of the present disclosure. It is to be understood that the signaling chart 1700 are given only for illustration purposes and the present disclosure is not limited thereto. The signaling chart 1700 may include additional operations or signaling not shown and/or may omit some shown blocks, and the scope of the present disclosure is not limited in this regard.

In FIG. 17, a conditional indirect path addition flow chart is illustrated. As illustrated, at the beginning of the flow chart, there was already a direct path. At 1701, the UE first conducts a relay discovery operation to discover potential relay UEs. At 1702, the UE 210 measures channel quality of the discovered relay UEs. At 1703, the UE 210 sends a measurement report related to channel quality information on the discovered relay UEs to the BS 210 on the direct path. At 1704, the BS 220 determines CAP conditions and multi-path configurations based on for example the measurement report. At 1705, the BS 220 sends a path addition command indicating the CPA configuration including CPA conditions and multi-path configurations to the UE 210. The multi-path configurations are already described with reference to FIGS. 7 to 8 and thus the detailed description will be omitted herein.

After the UE 210 receives the path addition command, it stores the CPA configurations at 1706 and sends a CPA command acknowledgement to the BS 220 at 1707. Then at 1708, the UE 210 conducts event evaluation to determine whether a new path shall be added. For example, the UE 210 may determine whether the target cell quality meets any of the CPA conditions. If it determines to add a new path at 1708, the UE establishes a PC 5 link with the relay UE at 1709 and the NR Uu link between the relay UE 230 and the BS 220 is established at 1710a, or 1710b. The establishment of NR Uu link between the relay UE 230 and the BS 220 can be initiated by the BS 210 (1710a) or by the UE (1710b). Thus, the relay UE is configured as a relay UE for the UE 210 at 1711. After the indirect path is established, the UE 210 applies the multi-path configuration at 1712. Thereafter, a path addition confirmation can be further fed back to the BS 220 via one or both of the direct path and the indirect path, at 1713a, 1713b. Then, at 1714, the UE 210 begins communication with the BS 220 on the newly added indirect path.

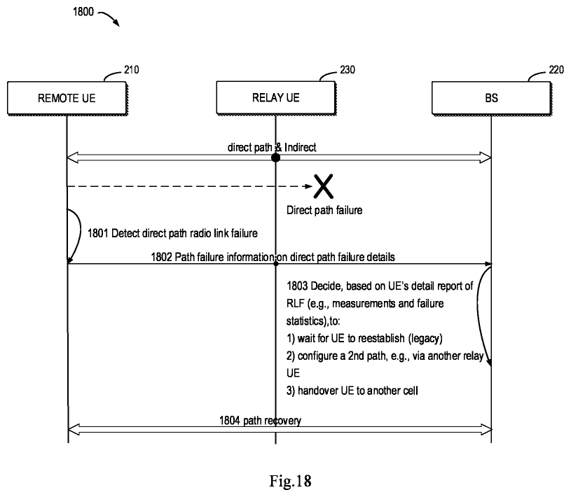

FIG. 18 illustrates a flowchart of a method of failure path recovery for the direct path according to some embodiments of the present disclosure. It is to be understood that the signaling chart 1800 are given only for illustration purposes and the present disclosure is not limited thereto. The signaling chart 1800 may include additional operations or signaling not shown and/or may omit some shown blocks, and the scope of the present disclosure is not limited in this regard.

As illustrated, at the beginning of the singling chart, both the direct and the indirect paths are available. However, there occurs a direct path failure. In such a case, the UE 210 may detect the path failure itself at 1801. At 1802, the UE 210 transmits path failure information on details of the direct path failure. At 1803, the BS 220 receives the path failure information and decides the strategy of the failure recovery. For example, the UE 210 could reestablish the direct path and the BS 220 could just wait the UE to reestablish the path. Alternatively, the BS may configure a second path, e.g., via another relay UE or handover the UE to another cell.

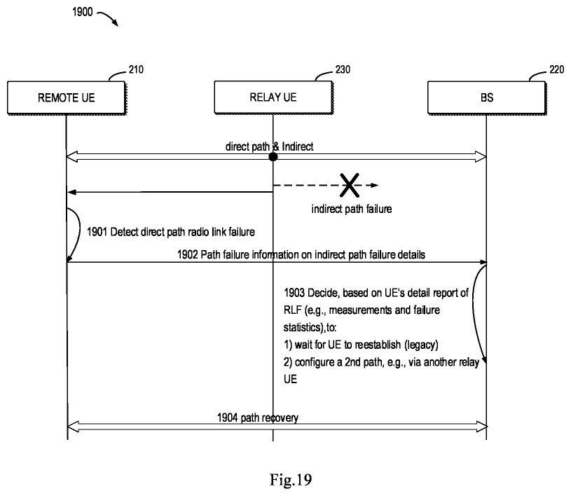

FIG. 19 illustrates a flowchart of a method of failure path recovery for the indirect path according to some embodiments of the present disclosure. It is to be understood that the signaling chart 1900 are given only for illustration purposes and the present disclosure is not limited thereto. The signaling chart 1900 may include additional operations or signaling not shown and/or may omit some shown blocks, and the scope of the present disclosure is not limited in this regard.

As illustrated, at the beginning of the singling chart, both the direct and the indirect paths are available. However, there occurs an indirect path failure. In such a case, the UE 210 may detect the path failure itself at 1901 if the path failure occurs between the remote UE 210 and the relay UE 220. Alternatively, the UE may be informed by the relay UE of the path failure between the relay UE 230 and the BS 220. Then, the UE 210 may further send path failure information on details of the direct path failure at 1902. At 1903, the BS 220 receives the path failure information and decides the strategy of the failure recovery. For example, the UE 210 could reestablish the direct path and the BS 220 could just wait the UE to reestablish the path. Alternatively, the BS may configure a second path, e.g., via another relay UE. At 1904, the path recovery is performed.

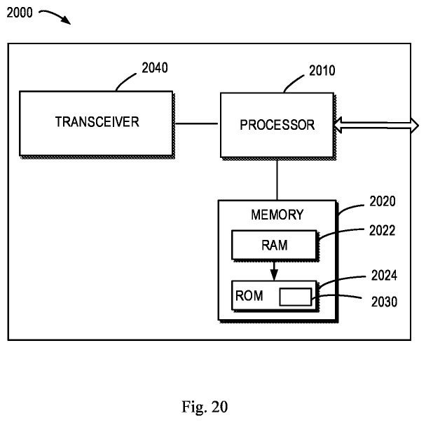

FIG. 20 is a simplified block diagram of a device 2000 that is suitable for implementing embodiments of the present disclosure. For example, the BS 220 and the UE 210 can be implemented by the device 2000. As shown, the device 2000 includes a processor 2010, a memory 2020 coupled to the processor 2010, and a transceiver 2040 coupled to the processor 2010.

The transceiver 2040 is for bidirectional communications. The transceiver 2040 is coupled to at least one antenna to facilitate communication. The transceiver 2040 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 2010 may be of any type suitable to the local technical network and may include one or more of the following: general purpose computers, special purpose computers, microprocessors, digital signal processors (DSPs) and processors based on multicore processor architecture, as non-limiting examples. The device 2000 may have multiple processors, such as an application specific integrated circuit chip that is slaved in time to a clock which synchronizes the main processor.

The memory 2020 may include one or more non-volatile memories and one or more volatile memories. Examples of the non-volatile memories include, but are not limited to, a Read Only Memory (ROM) 2024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 2022 and other volatile memories that will not last in the power-down duration.

A computer program 2030 includes computer executable instructions that are executed by the associated processor 2010. The program 2030 may be stored in the ROM 2024. The processor 2010 may perform any suitable actions and processing by loading the program 2030 into the RAM 2022.

The embodiments of the present disclosure may be implemented by means of the program 2030 so that the device 2000 may perform any process of the disclosure as discussed with reference to FIGS. 4-19. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out one or more of the methods as described above with reference to FIGS. 4 to 19.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A processor of a user equipment (UE) configured to perform operations comprising:
transmitting, to a base station, a measurement report on a first path between the UE and the base station, wherein the measurement report indicates channel quality information on one or more potential paths between the UE and the base station;
receiving a path addition command from the base station, wherein the path addition command instructs the UE to add a path from the one or more potential paths as a second path; and
establishing the second path between the UE and the base station based on the path addition command.

2. The processor of claim 1, wherein the operations further comprise:
transmitting, after the second path is established, a path addition confirmation to the base station, wherein the path addition confirmation is transmitted on one or both of the first path and the second path.

3. The processor of claim 1, wherein the operations further comprise:
transmitting UE capability information to the base station, wherein the UE capability information indicates whether the UE supports multi-path sidelink relay.

4. The processor of claim 1, wherein the second path is a direct path and establishing the second path between the UE and the base station further comprises:
transmitting a random access channel (RACH) request to the base station;
receiving a RACH response from the base station; and
applying a corresponding multi-path configuration.

5. The processor of claim 4, wherein the operations further comprise:
receiving a common RACH configuration in a system information block (SIB) or a dedicated RRC signaling, wherein the common RACH configuration or the dedicated RRC signaling contains resources for the RACH.

6. The processor of claim 1, wherein the second path is an indirect path and the operations further comprise:
discovering one or more potential relay UEs for indirect paths; and
performing channel measurements on the one or more potential relay UEs.

7. The processor of claim 6, wherein the path addition command indicates a target relay UE for the second path; and
wherein establishing the second path between the UE and the base station further comprises establishing a link between the UE and the target relay UE.

8. The processor of claim 1, wherein the operations further comprise one or more of:
transmitting a user preference for at least one of path adding or path removing via RRC signaling; or
transmitting an intention on path setup or path release using UE assistance information or sidelink UE information.

9. A processor of a user equipment (UE) configured to perform operations comprising:
receiving a conditional path addition (CPA) command from a base station on a first path between the UE and the base station, wherein the CPA command indicates a CPA configuration containing CPA trigger conditions and a multi-path configuration;
executing the CPA command in accordance with a determination that at least one of the CPA trigger conditions is fulfilled; and
establishing a second path between the UE and the base station in accordance with the determination that the CPA is to be executed.

10. The processor of claim 9, wherein the CPA configuration is per each candidate target cell or per each candidate relay UE, or
wherein CPA trigger conditions define CPA event triggers for triggering a CPA, or
wherein the multi-path configuration indicates at least one of a traffic split configuration or a traffic duplication configuration regarding traffic transmission, and is per target candidate cell to target candidate relay UE.

11. The processor of claim 9, wherein the operations further comprise:
transmitting a CPA command acknowledgement to the base station on the first path.

12. The processor of claim 9, wherein the operations further comprise:
transmitting, after the second path is established, a path addition confirmation to the base station, wherein the path addition confirmation is transmitted on one or both of the first path and the second path.

13. The processor of claim 9, wherein the operations further comprise one or both of:
transmitting UE capability information to the base station on the first path, wherein the UE capability information indicates whether the UE supports multi-path sidelink relay; or
transmitting, to the base station, a measurement report on the first path between the UE and the base station, wherein the measurement report indicates channel quality information on one or more potential paths between the UE and the base station.

14. The processor of claim 9, wherein the second path is a direct path and establishing the second path between the UE and the base station further comprises:
transmitting a random access channel (RACH) request to the base station;
receiving a RACH response from the base station; and
applying a corresponding multi-path configuration.

15. The processor of claim 14, wherein the operations further comprise:
receiving a common RACH configuration in a system information block (SIB) or a dedicated RRC signaling, wherein the common RACH configuration or a dedicated RRC signaling contains resources for the RACH.

16. The processor of claim 9, wherein the second path is an indirect path and the operations further comprise:
discovering one or more potential relay UEs for indirect paths; and
performing channel measurements on the one or more potential relay UEs.

17. The processor of claim 16, wherein establishing the second path between the UE and the base station further comprises establishing a link between the UE and a target relay UE.

18. The processor of claim 9, wherein the determination that at least one of the CPA trigger conditions is fulfilled is made based on measurement results of any candidate cell or candidate relay UE meeting one or more event thresholds relating to a measurement identifier for a corresponding path.

19. The processor of claim 9, wherein the operations further comprise one or more of:
transmitting a user preference for at least one of path adding or path removing via an RRC signaling; or
transmitting an intention on path establishment or path release using UE assistance information or sidelink UE information.

20-29. (canceled)

30. A processor of a base station (BS) configured to perform operations comprising:
receiving from, a user equipment (UE), a measurement report on a first path between the UE and the base station, wherein the measurement report indicates channel quality information on one or more potential paths between the UE and the base station;
determining a second path to be added from the one or more potential paths based on the measurement report;
transmitting a path addition command to the UE, wherein the path addition command instructs the UE to add a second path; and
assisting to establish the second path between the UE and the base station.

31-34. (canceled)
